(19) United States
(12) Patent Application Publication
(10) Pub. No.: US 2018/0281750 A1
(43) Pub. Date: Oct. 4, 2018

(54) WIPER DEVICE

(71) Applicant: HONDA MOTOR CO., LTD., Tokyo (JP)

(72) Inventor: Koji Okabe, Wako-shi (JP)

(21) Appl. No.: 15/926,253

(22) Filed: Mar. 20, 2018

(30) Foreign Application Priority Data
Mar. 31, 2017 (JP) 2017-072027

(51) Int. Cl. B60S 1/38; B60S 1/04

(52) U.S. Cl. CPC B60S 1/3806; B60S 2001/3836; B60S 1/0408

(57) ABSTRACT

A wiper device includes a long wiper blade mounted on a wiper arm provided in a vehicle and configured to wipe a surface of a glass window. The wiper blade includes a drain passage extending in a longitudinal direction of the wiper blade and formed to be hollow, and a communication path having one end communicating with the drain passage and the other end communicating with a surface of the wiper blade. The communication path is formed to have a width that draws, from the other end through the one end into the drain passage, water wiped by the wiper blade by a capillarity phenomenon, and a width of the drain passage in a direction orthogonal to the longitudinal direction is formed to be wider than the width of the communication path.

### BACKGROUND OF THE INVENTION

### Field of the Invention

The present invention relates to a wiper device including a long wiper blade that is mounted on a wiper arm provided in a vehicle and wipes the surface of a glass window.

### Description of the Related Art

Conventionally, a vehicle such as a car is mounted with a wiper device that ensures the visual field of a driver by wiping rainwater, dust, and the like adhering to a windshield. The wiper device includes a wiper arm that is swingably driven by an electric motor, and a wiper blade that is mounted on the wiper arm. The wiper blade includes a holder main body pivotably mounted on the distal end of the wiper arm, and a blade rubber held by the holder main body. When the blade rubber elastically contacts the windshield by the pressing force of the wiper arm and the elastic force of a vertebra, and the electric motor is thus driven to swingably drive the wiper arm, the blade rubber performs a reciprocating wiping operation on the windshield.

As an arrangement of draining rainwater wiped by such wiper blade, for example, Japanese Patent Laid-Open No. 11-334358 discloses an arrangement in which a drain gutter 2 is formed in a water guide 3 provided along the side edge of a front glass window 1 and lip-shaped ribs 4 for accelerating drainage of water to the drain gutter 2 are provided.

However, in the above-described arrangement disclosed in Japanese Patent Laid-Open No. 11-334358, only water flowing from the front glass window to the water guide 3 can be drained, and thus the amount of water that can be drained once is limited.

The present invention provides a wiper device that includes a wiper blade capable of draining, from a drain passage, water drawn from a communication path in order to drain more water.

### SUMMARY OF THE INVENTION

According to one aspect of the present invention, there is provided a wiper device including a long wiper blade mounted on a wiper arm provided in a vehicle and configured to wipe a surface of a glass window, wherein the wiper blade includes a drain passage extending in a longitudinal direction of the wiper blade and formed to be hollow, and a communication path having one end communicating with the drain passage and the other end communicating with a surface of the wiper blade, and wherein the communication path is formed to have a width that draws, from the other end through the one end into the drain passage, water wiped by the wiper blade by a capillarity phenomenon, and a width of the drain passage in a direction orthogonal to the longitudinal direction is formed to be wider than the width of the communication path.

A wiper device according to the present invention can drain, from a drain passage, water drawn from the communication path of a wiper blade.

Further features of the present invention will become apparent from the following description of exemplary embodiments (with reference to the attached drawings).

### BRIEF DESCRIPTION OF THE DRAWINGS

FIG. 1 is a view for explaining a wiper device mounted on a vehicle;

FIG. 2 is an enlarged perspective view showing a wiper blade in FIG. 1;

FIG. 3 is a sectional view taken along a line A-A in FIG. 2;

FIG. 4 is a view exemplifying an arrangement of draining, from a drain passage, water drawn from the communication path of the wiper blade;

FIG. 5 is a sectional view corresponding to FIG. 3, for explaining the flow state of traveling wind; and

FIG. 6 is a view showing a modification of the arrangement of the drain passage and the communication path.

### DESCRIPTION OF THE EMBODIMENTS

An embodiment of the present invention will be described below with reference to the accompanying drawings. Note that the constituent elements described in the embodiment are merely examples. The technical scope of the present invention is determined by the scope of claims and is not limited by the following individual embodiment.

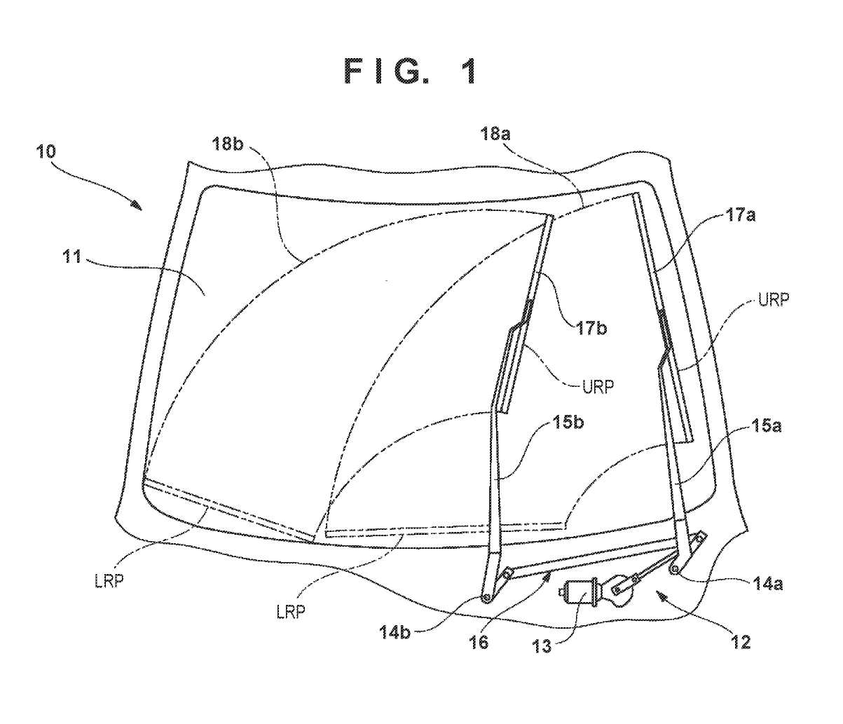

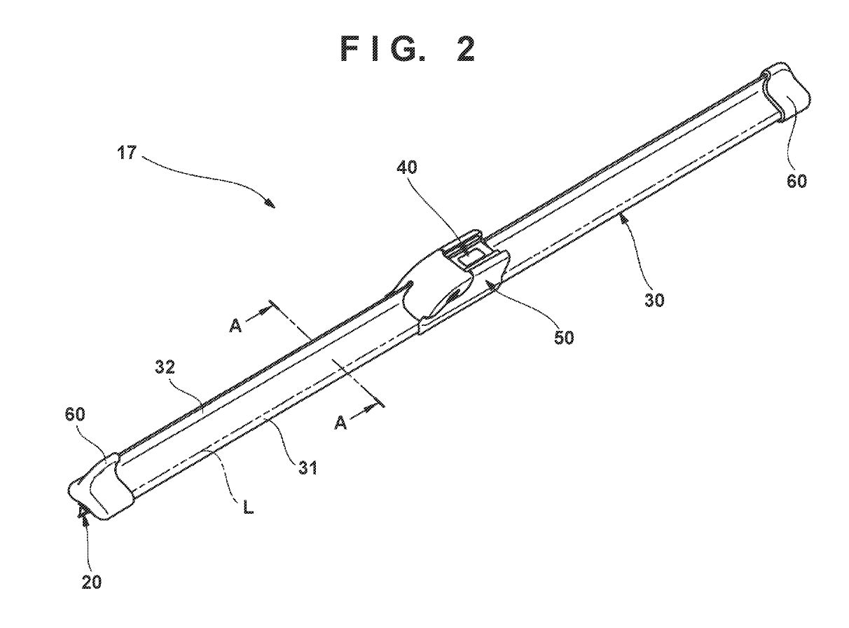

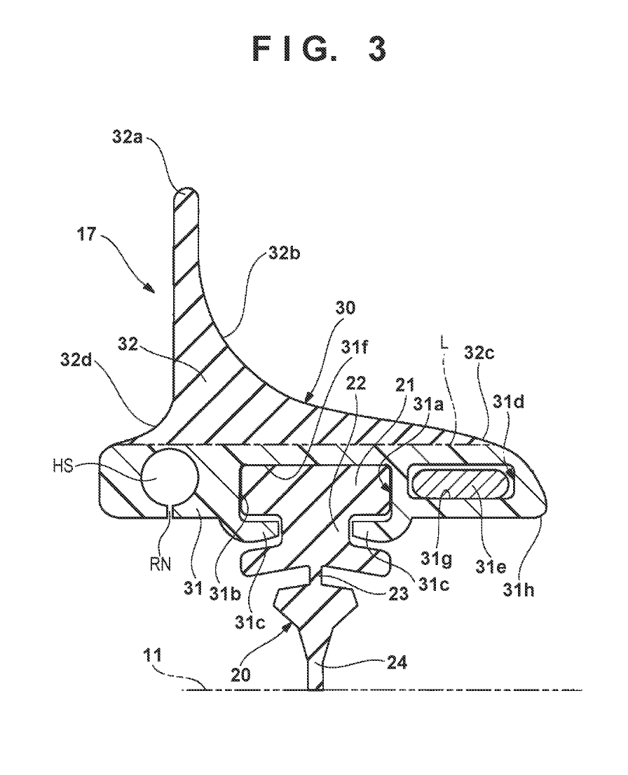

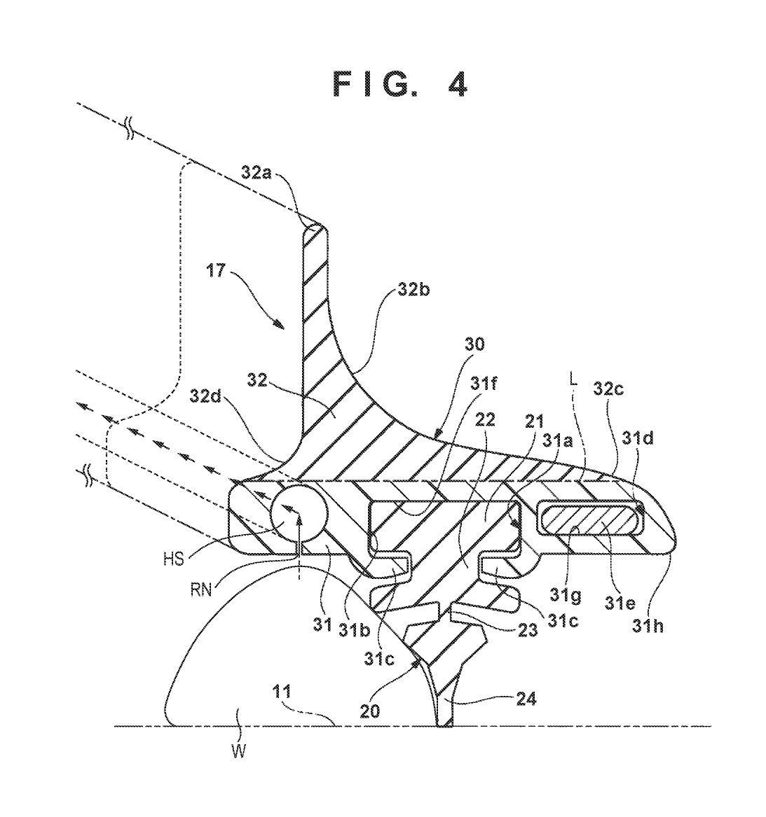

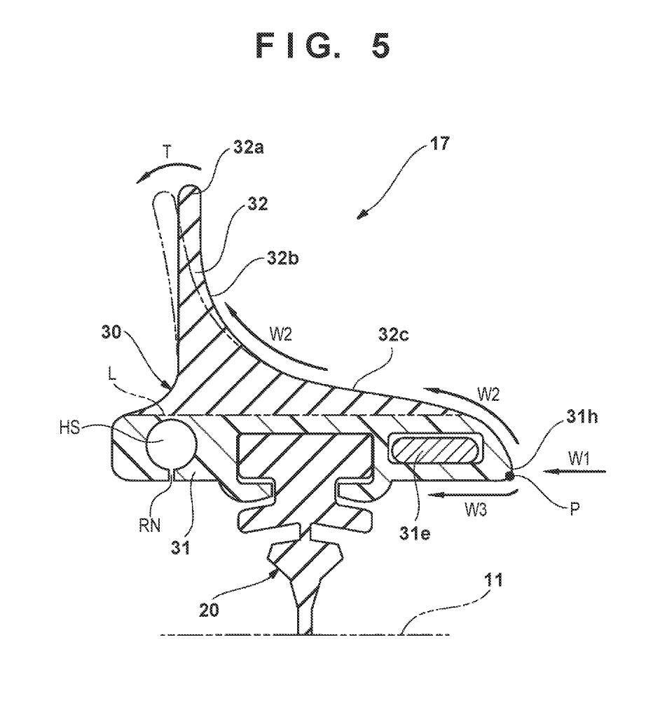

FIG. 1 is a view for explaining a wiper device mounted on a vehicle. FIG. 2 is an enlarged perspective view showing a wiper blade in FIG. 1. FIG. 3 is a sectional view taken along a line A-A in FIG. 2. FIG. 4 is a view exemplifying an arrangement of draining, from a drain passage, water drawn from the communication path of the wiper blade. FIG. 5 is a sectional view corresponding to FIG. 3, for explaining the flow state of traveling wind.

As shown in FIG. 1, a front glass window 11 as a windshield is provided on the front side of a vehicle 10 such as a car, and a wiper device 12 for ensuring the visual field of a driver by wiping rainwater, dust, and the like (not shown) adhering to the front glass window 11 is provided on the front side of the front glass window 11. The wiper device 12 is mounted in a cowl top or the like (not shown) located on the rear side of the engine room of the vehicle 10.

The wiper device 12 includes a wiper motor 13 as an electric motor rotationally driven by operating a wiper switch (not shown) provided in the interior of the vehicle or the like, pivot shafts 14a and 14b on a driver's seat side (DR-side) and passenger seat side (AS-side), both of which are pivotably provided in the vehicle 10, DR- and AS-side wiper arms 15a and 15b having proximal ends respectively fixed to the pivot shafts 14a and 14b and distal ends each performing a swing motion on the front glass window 11, and a link mechanism 16 for converting a rotational motion of the wiper motor 13 into a swing motion of each wiper arm 15a or 15b.

DR- and AS-side wiper blades 17a and 17b formed similarly are respectively mounted on the distal ends of the wiper arms 15a and 15b to be pivotable in the vertical direction of the front glass window 11, and the wiper blades 17a and 17b are configured to elastically contact the front glass window 11 by springs (not shown) provided in the wiper arms 15a and 15b, respectively. That is, the pressing forces of the wiper arms 15a and 15b are transmitted to the wiper blades 17a and 17b, respectively. By rotationally driving the wiper motor 13, each of the wiper blades 17a and 17b performs a reciprocating wiping operation within each of wiping ranges 18a and 18b indicated by two-dot dashed lines in FIG. 1 on the front glass window 11, that is, between a lower reversal position (the stop position of the wiper arm) LRP as a lower position along the lower edge of the front glass window 11 and an upper reversal position URP as an upper position along the side edge of the front glass window 11.

FIG. 2 shows the DR-side wiper blade. The DR- and AS-side wiper blades have the same arrangement. Thus, only the DR-side wiper blade will be described below. Furthermore, when explaining the DR-side wiper blade, constituent components of the DR-side wiper blade will be simply referred to as a “wiper blade” and the like without adding “DR-side”, and “a” and “b” suffixed to the reference numerals for discriminating between the DR side and the AS side will be omitted.

As shown in FIG. 2, the wiper blade 17 includes a blade rubber 20 that contacts the front glass window 11 and functions as a wiping portion for wiping the surface of the front glass window 11, a holder member 30 for holding the blade rubber 20 (wiping portion), an arm connecting member 40 provided in an intermediate portion of the holder member 30 in the longitudinal direction, a cover 50 for covering the arm connecting member 40, and a pair of end caps 60 mounted on two end portions of the holder member 30 in the longitudinal direction.

As shown in FIG. 3, the wiper device 12 according to the embodiment of the present invention is a wiper device including the long wiper blade 17 that is mounted on the wiper arm 15 provided in the vehicle and wipes the surface of the front glass window 11 as a windshield. The wiper blade 17 includes a drain passage HS extending in the longitudinal direction of the wiper blade and formed to be hollow, and a communication path RN having one end communicating with the drain passage HS and the other end communicating with the surface of the wiper blade 17. The communication path RN is formed to have a width that draws, from the other end through the one end into the drain passage HS, water wiped by the wiper blade by a capillarity phenomenon, and the width of the drain passage HS in a direction orthogonal to the longitudinal direction is formed to be wider than the width of the communication path. The width of the communication path RN is formed in a direction that is along the surface of the front glass window 11 and orthogonal to the longitudinal direction of the wiper blade 17.

The wiper device 12 according to this embodiment can actively draw water adhering to the surface of the front glass window 11 into the drain passage HS by the capillarity phenomenon of the communication path RN. Furthermore, using the drain passage HS with a width wider than that of the communication path RN, the wiper device 12 can quickly discharge the water drawn by the communication path RN, thereby drawing more water. In addition, the wiper blade 17 of the wiper device 12 can drain, from the drain passage HS, the water drawn from the communication path RN of the wiper blade 17, thereby discharging more water.

The wiper blade 17 pivots in the circumferential direction of a circle around the pivot shaft 14 between the lower position LRP (FIG. 1) along the lower edge of the front glass window 11 and the upper position URP (FIG. 1) along the side edge of the front glass window 11, and the drain passage HS includes a drain port in the outer end portion of the wiper blade 17 in the radial direction of the circle.

As shown in FIG. 3, the blade rubber 20 includes a main body portion 21, a body portion 22, a neck portion 23, and a lip portion 24. The blade rubber 20 is formed to be long by performing extrusion molding of an elastic material such as rubber, and has a uniform sectional shape over the entire region along the longitudinal direction. In the wiper device 12, the communication path RN is formed in the longitudinal direction of the wiper blade 17. In the arrangement of the communication path RN, it is possible to actively draw more water into the drain passage HS by the capillarity phenomenon of the communication path RN formed in the longitudinal direction of the wiper blade, and quickly discharge the drawn water by the drain passage HS with a width wider than that of the communication path RN.

The thickness dimension of the neck portion 23 is set to be smaller than that of the body portion 22, and is thus readily, elastically deformed. This allows inclination of the lip portion 24 when the wiper blade 17 slides on the front glass window 11, and the distal end portion of the lip portion 24 smoothly follows in the sliding direction of the wiper blade 17, thereby reliably wiping rainwater, dust, and the like adhering to the front glass window 11.

The holder member 30 includes a holder main body 31 and a fin portion 32, and the holder main body 31 and the fin portion 32 are integrated by performing two-color molding (extrusion molding) of materials with different hardnesses, and formed to be long. This can simplify the manufacturing step of the wiper blade 17. A two-dot dashed line L in FIG. 3 indicates the boundary line between the holder main body 31 and the fin portion 32. The drain passage HS is provided in, for example, the holder member 30, and the communication path RN has one end communicating with the drain passage HS, and the other end communicating with the surface of the wiper blade 17. In the example shown in FIG. 3, the holder member 30 includes a lower surface opposing the front glass window 11, and the other end of the communication path RN is open to the lower surface of the holder member 30.

The lower surface opposing the front glass window 11 is a surface that is along the front glass window 11 and almost parallel to the surface of the front glass window 11. In this arrangement of the wiper blade 17, the drain passage HS is provided in the holder member 30 having a spatial margin, and thus it is possible to ensure a large section of the drain passage HS, thereby improving discharge performance. Since neither the drain passage HS nor the communication path RN is provided in the wiping portion, it is possible to prevent the wiping performance of the wiping portion from deteriorating.

The holder member 30 includes the fin portion 32 extending upward above the wiping portion 20 with respect to the surface of the glass window, and the drain passage HS is provided at a position overlapping the fin portion in the longitudinal direction of the wiper blade 17.

By providing the fin portion 32, it is possible to smoothly guide traveling wind along the wiper blade 17 when the wiper blade 17 performs a reciprocating wiping operation on the front glass window 11, thereby improving aerodynamic performance. In addition, a portion of the holder member 30 in which the fin portion 32 is provided is thick. Even if the drain passage HS and the communication path RN are provided in this portion, deteriorating in rigidity of the holder member 30 can be suppressed. If the holder member 30 is resin-molded, the root of the fin portion 32 can be thinned by providing the drain passage HS, and it is thus possible to prevent a sink (shrinkage at the time of molding) of the surface of the holder member 30 (the root of the fin portion 32).

The holder main body 31 is made of a resin material such as plastic having flexibility so as to follow the front glass window 11 while ensuring a sufficient strength to hold the blade rubber 20. A holding portion 31a extending in the longitudinal direction of the holder main body 31 is formed in an intermediate portion of the holder main body 31 in a widthwise direction (in an intermediate portion in the right-and-left direction in FIG. 3). The holding portion 31a includes a concave holding groove 31b formed from a pair of side walls between which the main body portion 21 of the blade rubber 20 enters and an upper wall connecting the pair of side walls. A gap is formed between the main body portion 21 and the holding groove 31b, and the main body portion 21 is assembled inside the holding groove 31b via the gap. A pair of holding pawls 31c that support to cover a portion of the main body portion 21 on the side of the front glass window 11 and oppose each other to sandwich the body portion 22 is provided in a portion of the holding portion 31a on the side (the lower side in FIG. 3) of the front glass window 11. As described above, the holding portion 31a is formed from the holding groove 31b and the holding pawls 31c for holding the main body portion 21, and thus the blade rubber 20 is reliably held by the holder main body 31 without falling off.

A storing portion 31d having an almost rectangular shape as a sectional shape is provided on one side (the right side in FIG. 3) of the holder main body 31 in the widthwise direction. The storing portion 31d is formed to extend in the longitudinal direction of the holder main body 31, similarly to the holding portion 31a.

The storing portion 31d stores a plate-like vertebra 31e made of a steel material having a spring property, and the vertebra 31e is provided in the storing portion 31d to be movable in its longitudinal direction. The vertebra 31e is curved at a curvature larger than that of the front glass window 11 in a natural state in which no external force is loaded, and the entire region of the lip portion 24 in the longitudinal direction is in tight contact with the front glass window 11.

A rubber pressing portion 31f, corresponding to the upper wall of the holding groove 31b, for pressing the main body portion 21 of the blade rubber 20 against the front glass window 11 is formed in a portion, opposing the front glass window 11, of the holding groove 31b. Furthermore, a holder pressing portion 31g for pressing the holder main body 31 against the front glass window 11 by the elastic force of the vertebra 31e is formed in a portion, opposing the front glass window 11, of the storing portion 31d on the side of the front glass window 11 with respect to the rubber pressing portion 31f.

The vertebra 31e presses the holder pressing portion 31g of the storing portion 31d, and the pressing force of the vertebra 31e is transmitted to the rubber pressing portion 31f. The holder main body 31 and the blade rubber 20 are elastically deformed by the pressing force of the vertebra 31e in accordance with the curvature of the front glass window 11, and the entire region of the lip portion 24 in the longitudinal direction is in tight contact with the front glass window 11.

As shown in FIG. 3, the fin portion 32 is formed to be long using an elastic material such as rubber, and is integrally provided with the holder main body 31 in its longitudinal direction. The hardness of the fin portion 32 is set to be lower than that of the holder main body 31, thereby allowing the fin portion 32 to be elastically deformed by wind pressure of traveling wind (see FIG. 5).

The fin portion 32 is provided on the side, opposite to the side of the front glass window 11, of the holder main body 31, and a top portion 32a farthest from the front glass window 11 is formed on the distal end side (upper side in FIG. 3).

An upstream-side airflow surface portion 32b along which traveling wind flows is provided on one side of the fin portion 32 in the widthwise direction, and the upstream-side airflow surface portion 32b is formed to have an arc shape as the sectional shape of the fin portion 32 in the widthwise direction. A connecting surface portion 32c having an arc shape as the sectional shape of the fin portion 32 in the widthwise direction is provided between the upstream-side airflow surface portion 32b and an upstream-side lower end surface portion 31h. In addition, a downstream-side airflow surface portion 32d is provided on the other side (the left side in FIG. 3) of the fin portion 32 in the widthwise direction, and the section of the fin portion 32 in the widthwise direction is formed into an arc shape.

FIG. 4 is a view exemplifying an arrangement of draining, from the drain passage, water drawn from the communication path of the wiper blade. Water on the front glass window 11 is drawn from the other end of the communication path RN through the one end into the drain passage HS by the capillarity phenomenon, and drained in the direction of arrows in FIG. 4 from the drain passage HS formed in the longitudinal direction of the wiper blade 17. With this arrangement of the wiper blade 17, it is possible to actively drain water from the drain passage HS by the centrifugal force generated by the pivot of the wiper blade 17, thereby improving drainage performance, as compared with a case in which water is drained naturally by the gravity. Furthermore, since it is possible to discharge water from the drain passage HS to the roof side of the vehicle before the wiper blade 17 reaches a position close to a front pillar, the amount of water flowing toward a side panel across the front pillar can be further reduced.

The other end of the communication path RN may be formed to be open to the side of the side edge of the front glass window 11 with respect to the wiping portion 20 in a state in which the wiper blade 17 is located at the upper position URP. With this arrangement of the wiper blade 17, it is possible to draw, through the communication path RN by the pivot of the wiper blade 17, water collected on the front pillar side with respect to the wiping portion 20, thereby further reducing the amount of water flowing toward the side panel across the front pillar. Note that if the wiper blade 17 pivots toward the lower edge of the front glass window 11, water is scraped toward a cowl top panel, and thus there is no influence on the visual field of the driver. Therefore, the communication path RN is not provided on the lower edge side of the front glass window 11 with respect to the wiping portion 20. It is possible to suppress deterioration in rigidity of the holder member 30 by providing no communication path RN on the lower edge side of the front glass window 11 with respect to the wiping portion 20.

The flow state of traveling wind will be described next with reference to FIG. 5. If the wiper blade 17 receives traveling wind W1, the traveling wind W1 is divided into traveling wind W2 on the side of the fin portion 32 and traveling wind W3 on the side of the blade rubber 20 at a traveling wind branch point P.

The traveling wind W2 flows from the upstream-side lower end surface portion 31h to the top portion 32a along the connecting surface portion 32c and the upstream-side airflow surface portion 32b, and then flows to the other side (the left side in FIG. 5) of the holder main body 31 in the widthwise direction via the top portion 32a. By providing the fin portion 32, it is possible to smoothly guide the traveling wind along the wiper blade 17 when the wiper blade 17 performs a reciprocating wiping operation on the front glass window 11, thereby improving aerodynamic performance. If the traveling wind W2 is too strong, a narrow portion of the fin portion 32 on the side of the top portion 32a bends, as indicated by an arrow T in FIG. 5, and the traveling wind W2 is released to the other side of the holder main body 31 in the widthwise direction.

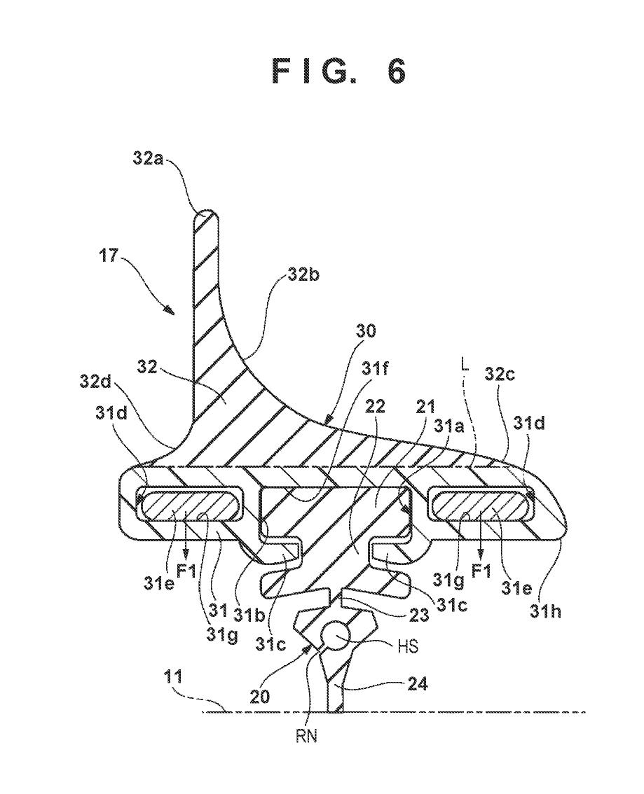

Note that in the wiper device 12 according to this embodiment, the arrangement of the drain passage HS and the communication path RN is not limited to that shown in FIG. 3. For example, an arrangement in which the drain passage is provided in the blade rubber 20 functioning as a wiping portion and the communication path is open to the side surface of the wiping portion may be adopted. For example, as shown in FIG. 6, an arrangement in which the drain passage HS is provided in the lip portion 24 forming the blade rubber 20 functioning as a wiping portion and the communication path RN is open to the side surface of the wiping portion may be adopted.

In the arrangement shown in FIG. 6, the vertebrae 31e are arranged on the left and right sides centered on the blade rubber 20, and pressing forces F1 of the respective vertebrae 31e are transmitted to the rubber pressing portion 31f as a resultant force. In this arrangement, it is possible to bring the entire region of the lip portion 24 in the longitudinal direction into tighter contact with the front glass window 11 while water adhering to the surface of the front glass window 11 can be actively drawn into the drain passage HS by the capillarity phenomenon of the communication path RN and the water drawn from the communication path RN can be drained from the drain passage HS, thereby making it possible to discharge more water.

A length (Z) from one end to the other end of the communication path RN satisfies:

Z<2T cos θ/(γr) (1)

T: surface tension of communication path RN

θ: contact angle between water and surface of communication path RN

γ: specific gravity of water

r: width of communication path RN/2

The contact angle indicates an angle formed, when the surface of the communication path (solid) contacts a liquid and a gas, by a liquid surface with a solid surface at a boundary where the three phases contact each other. In general, a tendency is indicated that the solid with a low surface tension readily gets wet and a contact angle when the liquid adheres is acute, and the solid with a high surface tension is difficult to get wet and a contact angle when the liquid adheres is obtuse. A drawing displacement (H) of water W by the capillarity phenomenon is given by H=2T cos θ/(γr) according to equation (1). By making the length (Z) of the communication path RN shorter than the drawing displacement (H) of the water W, it is possible to reliably draw, up to the drain passage HS, the water W drawn from the surface of the wiper blade 17, thereby implementing more effective drainage.

### Summary of Embodiment

Arrangement 1. There is provided a wiper device (for example, 12) according to the embodiment, including a long wiper blade (for example, 17) mounted on a wiper arm (for example, 15) provided in a vehicle and configured to wipe a surface of a glass window (for example, 11), characterized in that

the wiper blade (17) includes

a drain passage (for example, HS) extending in a longitudinal direction of the wiper blade and formed to be hollow, and

a communication path (for example, RN) having one end communicating with the drain passage and the other end communicating with a surface of the wiper blade,

the communication path (RN) is formed to have a width that draws, from the other end through the one end into the drain passage, water wiped by the wiper blade by a capillarity phenomenon, and

a width of the drain passage in a direction orthogonal to the longitudinal direction is formed to be wider than the width of the communication path.

According to the embodiment of arrangement 1, it is possible to actively draw, into the drain passage HS, water adhering to the surface of the front glass window 11 by the capillarity phenomenon of the communication path RN. Furthermore, using the drain passage HS with a width wider than that of the communication path RN, it is possible to quickly discharge the water drawn by the communication path RN, thereby drawing more water. In addition, the wiper blade 17 of the wiper device 12 can drain, from the drain passage HS, the water drawn from the communication path RN of the wiper blade 17, thereby discharging more water.

Arrangement 2. There is provided the wiper device according to the embodiment, characterized in that the communication path (RN) is formed in the longitudinal direction of the wiper blade (17).

According to the embodiment of arrangement 2, it is possible to actively draw more water into the drain passage HS by the capillarity phenomenon of the communication path RN formed in the longitudinal direction of the wiper blade, and quickly discharge the drawn water by the drain passage HS with a width wider than that of the communication path RN.

Arrangement 3. There is provided the wiper device (for example, 12) according to the embodiment, characterized in that

the wiper blade (17) includes

a wiping portion (20) contacting the glass window and configured to wipe the surface of the glass window, and

a holder portion (30) configured to hold the wiping portion and including a lower surface opposing the glass window,

the drain passage is provided in the holder portion, and

the other end of the communication path is open to the lower surface of the holder portion.

According to the embodiment of arrangement 3, since the drain passage HS is provided in the holder member 30 having a spatial margin, it is possible to ensure a large section of the drain passage HS, thereby improving discharge performance. Furthermore, since neither the drain passage HS nor the communication path RN is provided in the wiping portion, it is possible to prevent the wiping performance of the wiping portion from deteriorating.

Arrangement 4. There is provided the wiper device (for example, 12) according to the embodiment, characterized in that

the glass window is a front glass window (11),

the wiper blade (17) pivots in a circumferential direction of a circle around a pivot shaft (14) between a lower position (LRP) along a lower edge of the front glass window (11) and an upper position (URP) along a side edge of the front glass window (11), and

the drain passage (HS) includes a drain port in an outer end portion of the wiper blade in a radial direction of the circle.

According to the embodiment of arrangement 4, it is possible to actively drain water from the drain passage HS by the centrifugal force generated by the pivot of the wiper blade 17, thereby improving drainage performance, as compared with a case in which water is drained naturally by the gravity. Furthermore, since it is possible to discharge water from the drain passage HS to the roof side of the vehicle before the wiper blade 17 reaches a position close to a front pillar, the amount of water flowing toward a side panel across the front pillar can be further reduced.

Arrangement 5. There is provided the wiper device (for example, 12) according to the embodiment, characterized in that the other end of the communication path is open to a side of the side edge of the front glass window with respect to the wiping portion in a state in which the wiper blade (17) is located at the upper position (URP).

According to the embodiment of arrangement 5, it is possible to draw, through the communication path RN by the pivot of the wiper blade 17, water collected on the front pillar side with respect to the blade rubber 20, thereby further reducing the amount of water flowing toward the side panel across the front pillar.

Arrangement 6. There is provided the wiper device (for example, 12) according to the embodiment, characterized in that

the holder portion (30) includes a fin portion (for example, 32) extending upward above the wiping portion (20) with respect to the surface of the glass window, and

the drain passage (HS) is provided at a position overlapping the fin portion in the longitudinal direction of the wiper blade (17).

According to the embodiment of arrangement 6, by providing the fin portion 32, it is possible to smoothly guide traveling wind along the wiper blade 17 when the wiper blade 17 performs a reciprocating wiping operation on the front glass window 11, thereby improving aerodynamic performance. In addition, a portion of the holder member 30 in which the fin portion 32 is provided is thick. Even if the drain passage HS and the communication path RN are provided in this portion, deterioration in rigidity of the holder member 30 can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-072027, filed Mar. 31, 2017, which is hereby incorporated by reference herein in its entirety.

What is claimed is:

1. A wiper device including a long wiper blade mounted on a wiper arm provided in a vehicle and configured to wipe a surface of a glass window,
wherein the wiper blade includes
a drain passage extending in a longitudinal direction of the wiper blade and formed to be hollow, and
a communication path having one end communicating with the drain passage and the other end communicating with a surface of the wiper blade, and
wherein the communication path is formed to have a width that draws, from the other end through the one end into the drain passage, water wiped by the wiper blade by a capillarity phenomenon, and
a width of the drain passage in a direction orthogonal to the longitudinal direction is formed to be wider than the width of the communication path.

2. The device according to claim 1, wherein the communication path is formed in the longitudinal direction of the wiper blade.

3. The device according to claim 1,
wherein the wiper blade includes
a wiping portion contacting the glass window and configured to wipe the surface of the glass window, and
a holder portion configured to hold the wiping portion and including a lower surface opposing the glass window, and
wherein the drain passage is provided in the holder portion, and
the other end of the communication path is open to the lower surface of the holder portion.

4. The device according to claim 3, wherein
the glass window is a front glass window,
the wiper blade pivots in a circumferential direction of a circle around a pivot shaft between a lower position along a lower edge of the front glass window and an upper position along a side edge of the front glass window, and
the drain passage includes a drain port in an outer end portion of the wiper blade in a radial direction of the circle.

5. The device according to claim 4, wherein the other end of the communication path is open to a side of the side edge of the front glass window with respect to the wiping portion in a state in which the wiper blade is located at the upper position.

6. The device according to claim 3,
wherein the holder portion includes a fin portion extending upward above the wiping portion with respect to the surface of the glass window, and
wherein the drain passage is provided at a position overlapping the fin portion in the longitudinal direction of the wiper blade.
